(19) United States
(12) Patent Application Publication
(10) Pub. No.: US 2020/0310709 A1
(43) Pub. Date: Oct. 1, 2020

(54) METHOD AND SYSTEM FOR RESOURCE ENFORCEMENT ON A MULTI-FUNCTION PRINTER

(71) Applicant: Konica Minolta Laboratory U.S.A., Inc., San Mateo, CA (US)

(72) Inventors: Rahul Suraparaju, Fremont, CA (US); Amitha Hebbar, Foster City, CA (US)

(73) Assignee: Konica Minolta Laboratory U.S.A., Inc., San Mateo, CA (US)

(21) Appl. No.: 16/370,111

(22) Filed: Mar. 29, 2019

(51) Int. Cl. G06F 3/12; G06F 16/27; G06F 21/41; H04L 9/32

(52) U.S. Cl. CPC G06F 3/1229; G06F 3/1218; G06F 16/275; H04L 9/3263; G06F 21/41; H04L 9/3213; G06F 3/1292

(57) ABSTRACT

A method, a non-transitory computer readable medium, and a mobile device are disclosed for resource enforcement. The method includes: hosting a database of resource enforcement parameters for one or more users on an authentication server; receiving authentication credentials from a user from a mobile client on the authentication server; authenticating the user upon the receipt of authentication credentials from the mobile device; and issuing a digital certificate for the user with resource enforcement parameters to the user from the database of resource enforcement parameters for one or more users on the authentication server.

### FIELD OF THE INVENTION

The present disclosure generally relates to a method and system for resource enforcement on a multi-function printer (MFP), and more particularly, a method and system for resource enforcement on a plurality of multi-function printers from a mobile client and a mobile device management (MDM) server.

### BACKGROUND OF THE INVENTION

Single sign-on (SSO) is an authentication process that allows a user to access multiple applications with one set of login credentials. Single sign-on, for example, is a common procedure in enterprises, where a client accesses multiple resources connected to a local area network (LAN).

Variations of single sign-on authentication has been developed using mobile devices as access credentials. For example, mobile devices can be used to automatically log the user onto multiple systems, such as building-access-control systems and computer systems, through the use of authentication methods which include OpenID Connect and SAML, in conjunction, for example, with an X.509 ITU-T cryptography certificate used to identify the mobile device to an access server.

Current technologies involved in enforcing the resource parameters (for example, maximum number of color pages a user can print in a day) on a multifunction printer (MFP) or an image forming apparatus do not provide for dynamic and automated ways. Existing technologies enforce parameters either in global-configuration fashion (for example, all users inherit a flat provisioning value and/or same configuration for all devices) or in some case they are at user/group level, but the enforcement is not automated.

Eventually, such enforcement of enterprise resources becomes non-automatable, and therefore become ineffective. Existing techniques to enforce them involve various moving parts, such as administrator's involvement in checking and confirming and the need for everybody to ‘trust’ admin, as he/she is single point of trust. For example, an administrator may needs to continuously check log messages system alarms before concluding any resource abuse, which process is ineffective, cumbersome, and is not cost-effective.

### SUMMARY OF THE INVENTION

In consideration of the above issues, it would be desirable to have a method and system for completely automating a resource enforcement process in a dynamic and granular fashion through a method deployed by a document management and storage system server having a user authentication system (for example, a SPS server) and user mobile device management (MDM) server in an enterprise.

A method is disclosed for resource enforcement, the method comprising: hosting a database of resource enforcement parameters for one or more users on an authentication server; receiving authentication credentials from a user from a mobile client on the authentication server; authenticating the user upon the receipt of authentication credentials from the mobile device; and issuing a digital certificate for the user with resource enforcement parameters to the user from the database of resource enforcement parameters for one or more users on the authentication server.

A non-transitory computer readable medium storing computer readable program code executed by a processor for a method for resource enforcement is disclosed, the method comprising: hosting a database of resource enforcement parameters for one or more users on an authentication server; receiving authentication credentials from a user from a mobile client on the authentication server; authenticating the user upon the receipt of authentication credentials from the mobile device; and issuing a X.509 digital certificate for the user with resource enforcement parameters in an extension option of the X.509 certificate to the user from the database of resource enforcement parameters for one or more users on the authentication server.

A system is disclosed for resource enforcement, the system comprising: an authentication server configured to: host a database of resource enforcement parameters for one or more users; receive authentication credentials from a user from a mobile client; authenticate the user upon the receipt of authentication credentials from the mobile device; and issue a X.509 digital certificate for the user with resource enforcement parameters in an extension option of the X.509 certificate to the user from the database of resource enforcement parameters for one or more users on the authentication server.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for resource enforcement, for example, for multi-function printers accessed from a mobile client and/or a client in accordance with an exemplary embodiment.

FIG. 2 is an illustration of a computer or a server in accordance with an exemplary embodiment.

FIG. 3A is an illustration of a mobile device in accordance with an exemplary embodiment.

FIG. 3B is an illustration of a display unit or user interface of a mobile device in accordance with an exemplary embodiment.

FIG. 4 is an illustration of a multi-function printer or printer in accordance with an exemplary embodiment.

FIG. 5 is an illustration of a flow of an enforcement policy in accordance with an exemplary embodiment.

FIG. 6 is a database of enforcement parameters for a plurality of users in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

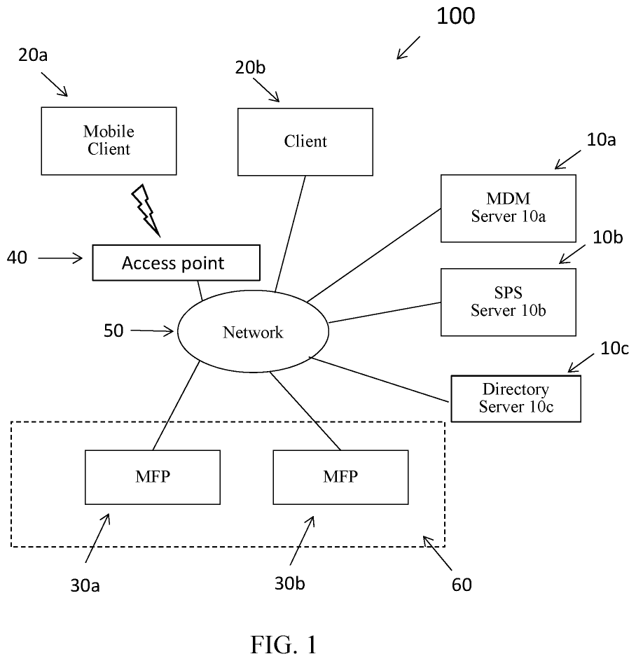

FIG. 1 is an illustration of a system 100 for resource enforcement, for example, for multi-function printers 30a, 30b accessed from a mobile client 20a and/or a client 20b in accordance with an exemplary embodiment. As shown in FIG. 1, the system 100 can include one or more mobile clients or mobile computers 20a, one or more clients or computers 20b, one or more mobile device management (MDM) servers 10a, one or more user authentication system servers 10b, for example, a SharePoint® servers (SPS), one or more directory servers 10c, and one or more multi-function printers or image forming apparatuses 30a, 30b. In accordance with an exemplary embodiment, the one or more mobile clients or mobile computers 20a, the one or more clients or computers 20b, the one or more mobile device management (MDM) servers 10a, the one or more user authentication system servers 10b, the one or more directory servers 10c, and one or more multi-function printers or image forming apparatuses 30a, 30b can be connected via a communication network 50. In accordance with an exemplary embodiment, the one or more multi-function printers or image forming apparatuses 30a, 30b, can be part of a local area network (LAN) 60, and managed, for example, by the one or more mobile device management servers 10a.

In accordance with an exemplary embodiment, the communication network or network 50 can be a public telecommunication line and/or a network (for example, LAN or WAN). Examples of the communication network 50 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

In addition, for example, an access point 40 can communicate with the communication network 50 to provide wireless or cellular data communication between the mobile computer (for example, a smart phone) 20a, and the communication network 50. In accordance with an exemplary embodiment, the access point 40 can be any networking hardware device that allows a Wi-Fi device to connect to a wired network, or a hardware device that can allow a cellular device, for example, the mobile computer (or smartphone) 20a to connect to the wired network 50.

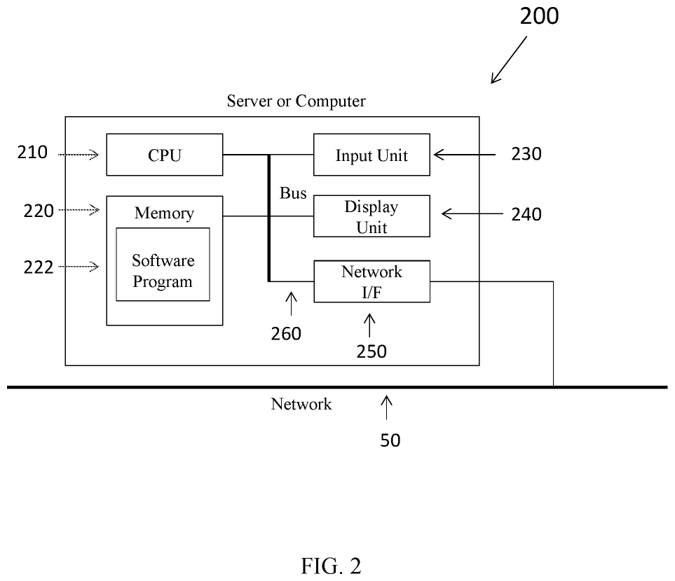

FIG. 2 is an illustration of a computing device 200, which can be a mobile device management server 10a, a document management and storage system servers 10b, a directory server 10c, or client device or computer 20b. As shown in FIG. 2, the exemplary computing device 200 can include a processor or central processing unit (CPU) 210, and one or more memories 220 for storing software programs and data 222. The processor or CPU 210 carries out the instructions of a computer program, which operates and/or controls at least a portion of the functionality of the computing device 200. The computing device 200 can also include an input unit 230, a display unit or graphical user interface (GUI) 240, and a network interface (I/F) 250, which is connected to a communication network (or network) 50. A bus 260 can connect the various components 210, 220, 230, 240, 250 within the computing device 10a, 10b, 10c, 20b.

In accordance with an exemplary embodiment, the computing device 200 can include a display unit or graphical user interface (GUI) 240, which can access, for example, a web browser (not shown) in the memory 220 of the computing device 200. The computing device 200 also includes an operating system (OS), which manages the computer hardware and provides common services for efficient execution of various software programs. In accordance with an exemplary embodiment, the OS of the CPU 210 is a Linux or Windows® based operating system. The software programs can include, for example, application software and printer driver software. For example, the printer driver software controls a multifunction printer or printer (not shown), for example connected with the computing device 200 in which the printer driver software is installed via the communication network 50. In certain embodiments, the printer driver software can produce a print job and/or document based on an image and/or document data.

In accordance with an exemplary embodiment, the computing device 200 is a mobile device management (MDM) server 10a is configured to administer mobile client or mobile client devices 20a, for example, smartphones, tablet computer, laptops, and desktop computers. For example, the MDM server 10a can be a combination of on-device applications and configurations, corporate policies and certificates, and backend infrastructure, for the purpose of simplifying and enhancing the information technology (IT) management of end user devices, for example, mobile clients 20a. In accordance with an exemplary embodiment, the MDM server 10a is designed to increase supportability, security, and corporate functionality of mobile clients 20a while maintaining some user flexibility.

In accordance with an exemplary embodiment, the MDM server 10a can be configured to administer devices and applications using mobile device management products and services, which can include corporate data segregation, securing emails, securing corporate documents on devices, enforcing corporate policies, integrating and managing mobile devices including laptops and handhelds of various categories. In accordance with an exemplary, the mobile device management implementations may be either on-premises or cloud-based. For example, the MDM server 10a can be configured to ensure that diverse user equipment is configured to a consistent standard/supported set of applications, functions, or corporate policies; update equipment, applications, functions, or policies in a scalable manner; ensure that users use applications in a consistent and supportable manner, ensure that equipment performs consistently, monitor and track equipment (e.g. location, status, ownership, activity), and efficiently diagnose and troubleshoot equipment remotely. For example, in accordance with an exemplary embodiment, the MDM server 10a can be configured to handle distribution of applications, data and configuration settings for all types of mobile devices, including mobile phones, smartphones, tablet computers, mobile computers, and mobile printers.

In accordance with an exemplary embodiment, the computing device 200 is a document management and storage system server 10b, for example, a SharePoint® server (SPS). In accordance with an exemplary embodiment, the document management and storage system server 10b is configured to handle enterprise content and document management, for example, for storage, retrieval, searching, archiving, tracking, management, and reporting on electronic documents and records. In accordance with an exemplary embodiment, the SPS server 10b can be used as intranet or intranet portal to centralize access to enterprise information and applications, collaborative software, file hosting, and custom web applications. For example, the SPS server 10b can be configured to handle various application programming interfaces, for example, application programming interfaces, (APIs: client-side, server-side, JavaScript), REST, SOAP, and Odata-based interfaces, and claims-based authentication, relying on, for example, SAML tokens for security assertions and/or an open authentication plugin model

In accordance with an exemplary embodiment, the SPS server 10b can be configured to handle authentication of mobile clients or mobile devices 20a, for example, via a single sign-on (SSO) method. Single sign-on is an authentication process that allows a user to access multiple applications with one set of login credentials. Single sign-on, for example, is a common procedure in enterprises, where a user (or client) accesses multiple resources connected to a local area network (LAN) 60. For example, the single sign-on, which authenticates a user, for example, by fingerprint recognition or authentication, or other authentication protocols, which are currently implemented or will be implemented on mobile devices. For example, a password authentication protocol, which uses credentials, such as username and password can be used.

In accordance with an exemplary embodiment, the SSO method can be Security Assertion Markup Language (SAML), which is an XML standard for exchanging single sign-on (SSO) information between an SAML Federation Identity Provider (SAML-IdP) who asserts the user identity and a SAML Federation Service Provider (SAML-SP) who consumes the user identity information. SAMLv2.0 (Security Assertion Markup Language version 2) supports IDP-initiated and SP-initiated flows. In IdP-initiated SAML SSO flow, the SAML-IdP creates a SAML single sign-on assertion for the user identity; and sends the SAML single sign-on assertion to the SP (Service Provider) in an unsolicited fashion. In SP-initiated SAML SSO flow, the SP generates a SAML2.0 AuthnRequest (i.e., Authentication Request) that is sent to the SAML-IdP as the first step in the Federation process and the SAML-IdP then responds with a SAML Response, both of these interactions being asynchronous to each other.

In accordance with an exemplary embodiment, the SSO method can be OpenID Connect (OIDC), which is an identity layer on top of an OAuth 2.0 protocol, which allows computing clients to verify the identity of an end-user based on the authentication performed by an authorization server, as well as to obtain basic profile information about the end-user in an interoperable and REST-like manner. In technical terms, OpenID Connect specifies a RESTful (Representational State Transfer), HTTP (hypertext transfer protocol), and API (application program interface), using JSON (JavaScript Objection Notation) as a data format. OpenID Connect, for example, allows a range of clients, including Web-based, mobile, and JavaScript clients, to request and receive information about authenticated sessions and end-users. The specification suite can also support optional features such as encryption of identity data, discovery of OpeniD Providers, and session management.

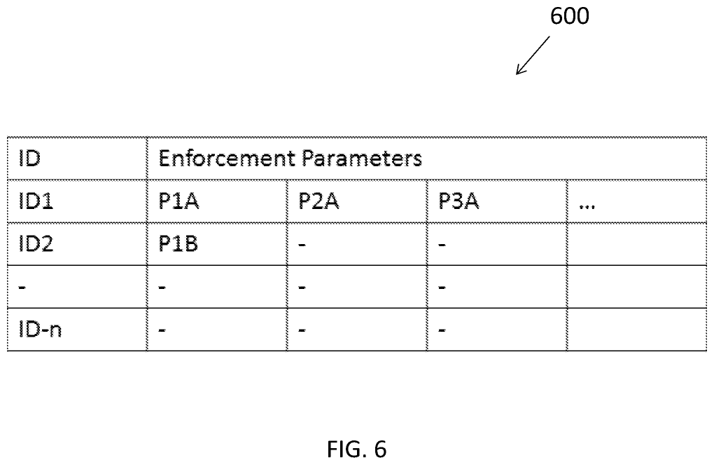

In accordance with an exemplary embodiment, the computing device 200 is a directory server 10c, which is configured to host a database (FIG. 6) of resource parameters, which can be executed, for example, on the multi-function printer (MFP), imaging forming apparatus, the printer or the printing device 30a, 30b as disclosed herein. For example, the directory server 10c can be an Active Directory (AD) server, or a lightweight directory access protocol (LDAP) server. In accordance with an exemplary embodiment, the managing of mobile clients 20a in enterprise systems is primarily performed, for example, by a MDM server 10a. However, as more workers have bought smartphone and tablet computing devices and have sought support for using these devices in the workplace, there are additional needs to control access to resources, for example, on devices, such as multifunction printers (MFPs) and image forming apparatuses 30a, 30b with a local area network (LAN). For example, enterprise software can include computer programs with common business applications, tools for modeling how the entire organization works, and development tools for building applications unique to the organization.

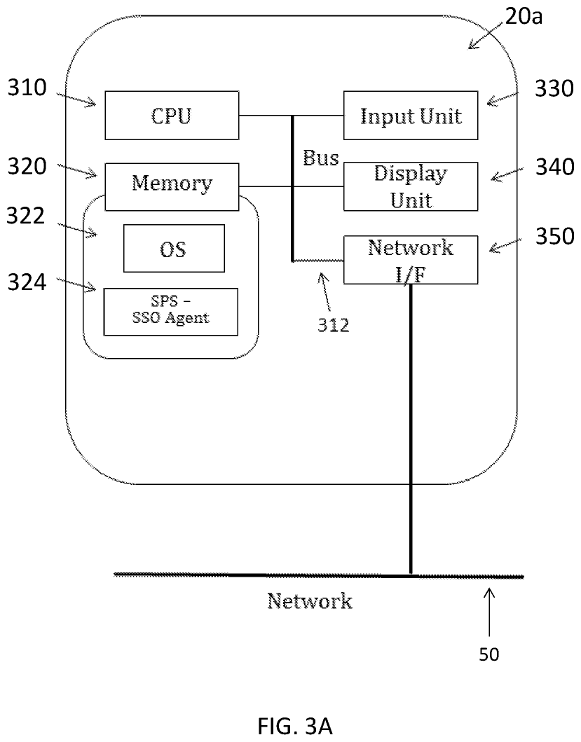

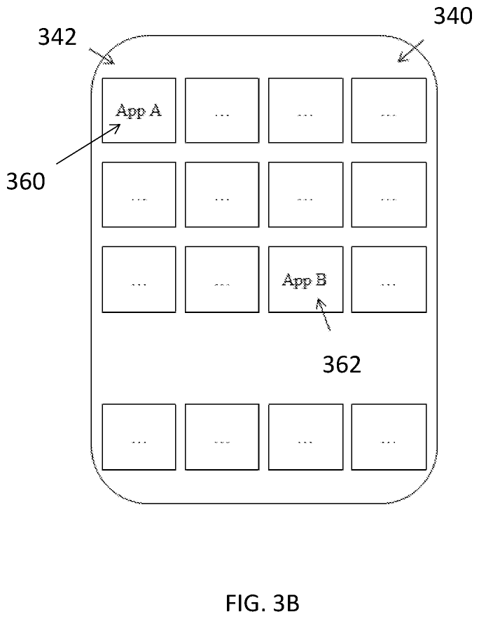

FIG. 3A is an illustration of a mobile client (or mobile device) 20a in accordance with an exemplary embodiment. As shown in FIG. 3A, the exemplary mobile client (or mobile device) 20a can include a processor or central processing unit (CPU) 310, and one or more memories 320 for storing software programs and data, an operating system 322, and an SPS-SSO agent 324. In accordance with an exemplary embodiment, the memory 320 includes the SPS-SSO agent 322, wherein the SPS-SSI agent 332 is configured to perform, for example, one or more the processes for enabling OIDC and SAML flows on a mobile application on the mobile device 300 via single sign-on (SSO) protocol. The processor or CPU 310 carries out the instructions of a computer program, which operates and/or controls at least a portion of the functionality of the mobile client (or mobile device) 20a. The mobile device 300 can also include an input unit 330, a display unit or graphical user interface (GUI) 340, and a network interface (I/F) 350, which is connected to a communication network (or network) 150. A bus 312 can connect the various components 310, 320, 330, 340, 350 within the mobile client (or mobile device) 20a.

In accordance with an exemplary embodiment, the mobile client (or mobile device) 20a can include a display unit or graphical user interface (GUI) 340, which can access, for example, a web browser (not shown) in the memory 320 of the mobile client (or mobile device) 20a. The mobile client (or mobile device) 20a also includes the operating system (OS) 322, which manages the computer hardware and provides common services for efficient execution of various software programs. In accordance with an exemplary embodiment, the OS 322 of the mobile client (or mobile device) 20a is a Linux or Windows® based operating system. The software programs can include, for example, application software and printer driver software. For example, the printer driver software controls a multifunction printer or printer (not shown), for example connected with the mobile client (or mobile device) 20a in which the printer driver software is installed via the communication network 50. In certain embodiments, the printer driver software can produce a print job and/or document based on an image and/or document data

In accordance with an exemplary embodiment, the mobile client (or mobile device) 20a can also preferably include an authentication module, which authenticates a user, for example, by a single sign-on (SSO) method such as a biometric, for example, a fingerprint, palm veins, face recognition, DNA, palm print, hand geometry, iris recognition, and/or retina, or authentication, or other authentication protocol, which are currently implemented or will be implemented on mobile devices. For example, a password authentication protocol, which uses credentials, such as username and password can be used. In accordance with an exemplary embodiment, the SPS server 10b can include a single sign-on (SSO) service. In accordance with an exemplary embodiment, the authentication module can be for access to the mobile client (or mobile device 20a) and/or used in connection with a single sign-on (SSO) process as disclosed herein.

FIG. 3B is an illustration of a display unit or user interface (also known as a graphical user interface (GUI) 340 of a mobile client (or mobile device) 20a in accordance with an exemplary embodiment. As shown in FIG. 3B, the display unit or user interface 340 can be a touch screen (or touch pad) 342 having a plurality of icons 360, 362 for frequently used applications, for example, a print application, a telephone module, an e-mail client module, a browser module, a video and music player module, a messages module, a calendar, a camera module, maps, weather, and application or module, which provides access to settings for the mobile client (or mobile device) 20a and various applications.

In accordance with an exemplary embodiment, the mobile application (or software component) is an interface 360, 362 on the mobile client (or mobile device) 20a in which the user is authenticated before the user can avail (or access) any services from, for example, on premises software (for example, On Premises Legacy) and/or off premises software (for example, Cloud services). In accordance with an exemplary embodiment, the authentication of the user via a single sign-on (SSO) method (or protocol) can be done, for example, via biometrics, such as finger print, facial identification or facial recognition, iris detection, and/or username and PIN (personal identification number).

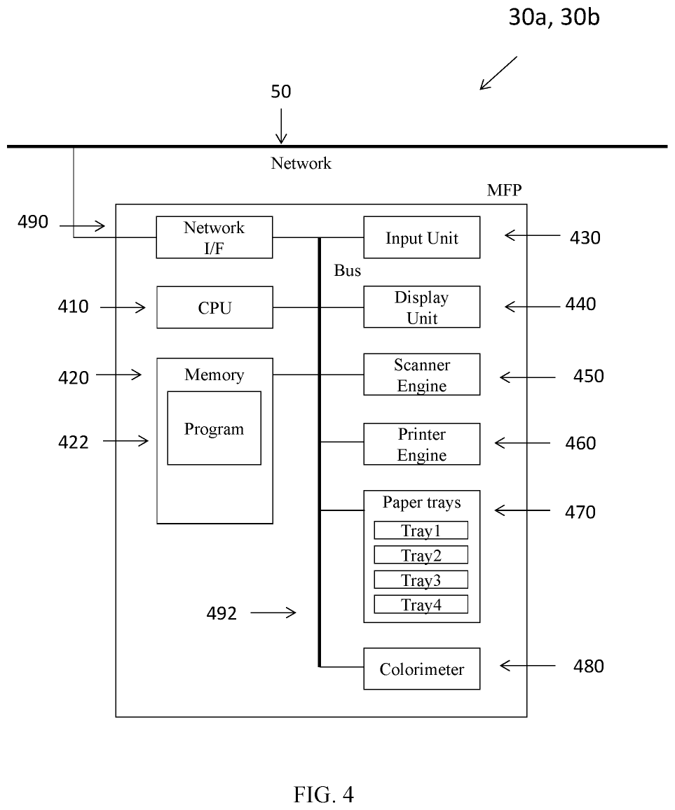

FIG. 4 is an illustration of a multi-function printer (MFP), an imaging forming apparatus, a printer or a printing device 30a, 30b in accordance with an exemplary embodiment. As shown in FIG. 4, the multi-function printer (MFP), imaging forming apparatus, the printer or the printing device 30a, 30b can include a network interface (I/F) 490, which is connected to the communication network (or network) 50, a processor or central processing unit (CPU) 410, and one or more memories 420 for storing software programs and data (such as files to be printed) 422. For example, the software programs 422 can include a printer controller and a tray table. The processor or CPU 410 carries out the instructions of a computer program, which operates and/or controls at least a portion of the functionality of the multi-function printer (MFP), imaging forming apparatus, the printer or the printing device 30a, 30b. The multi-function printer (MFP), imaging forming apparatus, the printer or the printing device 30a, 30b can also include an input unit 430, a display unit or graphical user interface (GUI) 440, a scanner engine (or scanner) 450, a printer engine 460, a plurality of paper trays 470, and a colorimeter 480.

In accordance with an exemplary embodiment, the colorimeter 480 can be an inline colorimeter (ICCU) (or spectrophotometer), which measures printed color patches in order to generate color profiles. In accordance with an exemplary embodiment, for example, the colorimeter (or spectrophotometer) 411 can be one or more color sensors or colorimeters, such as an RGB scanner, a spectral scanner with a photo detector or other such sensing device known in the art, which can be embedded in the printed paper path, and an optional finishing apparatus or device (not shown). A bus 492 can connect the various components 410, 420, 430, 440, 450, 460, 470, 480, and 490 within the multi-function printer (MFP), imaging forming apparatus, the printer or the printing device 30a, 30b. The multi-function printer (MFP), imaging forming apparatus, the printer or the printing device 30a, 30b also includes an operating system (OS), which manages the computer hardware and provides common services for efficient execution of various software programs. In accordance with an exemplary embodiment, it can be within the scope of the disclosure for the multi-function printer (MFP), imaging forming apparatus, the printer or the printing device 30a, 30b to be a copier.

For example, in accordance with an exemplary embodiment, an image processing section within the multi-function printer (MFP), imaging forming apparatus, the printer or the printing device 30a, 30b can carry out various image processing under the control of a print controller or CPU 410, and sends the processed print image data to the print engine 460. The image processing section can also include a scanner section (scanner engine 450) for optically reading a document, such as an image recognition system. The scanner section receives the image from the scanner engine 450 and converts the image into a digital image. The print engine 460 forms an image on a print media (or recording sheet) based on the image data sent from the image processing section. The central processing unit (CPU) (or processor) 410 and the memory 420 can include a program for RIP processing (Raster Image Processing), which is a process for converting print data included in a print job into Raster Image data to be used in the printer or print engine 460. The CPU 410 can include a printer controller configured to process the data and job information received from the one or more servers 10a, 10b, 10c, or the one or more mobile clients 20a, or client computers 20b, for example, received via the network connection unit and/or input/output section (I/O section) 490.

The CPU 410 can also include an operating system (OS), which acts as an intermediary between the software programs and hardware components within the multi-function peripheral. The operating system (OS) manages the computer hardware and provides common services for efficient execution of various software applications. In accordance with an exemplary embodiment, the printer controller can process the data and job information received from the one or more mobile clients 20a, or the one or more client computers 20b to generate a print image.

In accordance with an exemplary embodiment, the network I/F 490 performs data transfer with the one or more servers 10a, 10b, 10c, and the one or more client devices 20a, 20b. The printer controller can be programmed to process data and control various other components of the multi-function peripheral to carry out the various methods described herein. In accordance with an exemplary embodiment, the operation of printer section commences when the printer section receives a page description from the one or more servers 10a, 10b, 10c, and the one or more client devices 20a, 20b via the network I/F 490 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of the multi-function printer (MFP), imaging forming apparatus, the printer or the printing device 30a, 30b consistent with exemplary embodiments of the disclosure include, but are not limited to, a multi-function peripheral (MFP), a laser beam printer (LBP), an LED printer, a multi-function laser beam printer including copy function.

In accordance with an exemplary embodiment, the multi-function printer (MFP), imaging forming apparatus, the printer or the printing device 30a, 30b can also include at least one auto tray or paper tray 470, and more preferably a plurality of auto trays or paper trays. Each auto tray or paper tray 470 can include a bin or tray, which holds a stack of a print media (not shown), for example, a paper or a paper-like product. The printer engine or print engine 460 has access to a print media of various sizes and workflow for a print job, which can be, for example, stored in the input tray. A “print job” or “document” can be a set of related sheets, usually one or more collated copy sets copied from a set of original print job sheets or electronic document page images, from a particular user, or otherwise related.

In accordance with an exemplary embodiment, the print media is preferably a paper or paper-like media having one or more print media attributes. The print media attributes can include, for example, paper color, coating, grain direction, printing technology, brightness, CIE, tint, whiteness, labColor, etc. In order to maximize print quality, the print media attributes of each type of print media should be input into or hosted on the printer 30a, 30b, for example, on printer configuration settings of the multi-function printer (MFP), imaging forming apparatus, the printer or the printing device 30a, 30b to obtain the highest quality output. Most print media is provided in reams or other known quantities, which are packaged with indicia such as information on the manufacture, size, type and other attributes of the print media. In addition, most bundles or reams of paper include a UPC (Universal Product Code) or bar code, which identifies the type of print media including manufacture of the print media.

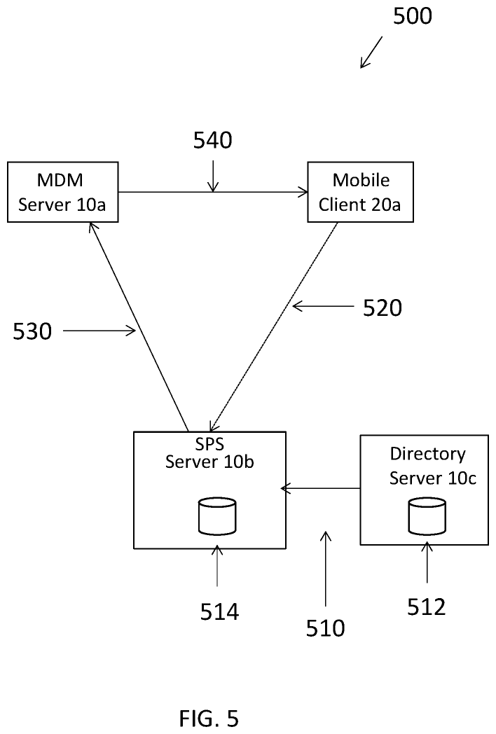

FIG. 5 is an illustration of a flow 500 of an enforcement policy in accordance with an exemplary embodiment. As shown in FIG. 5, the directory server 10c hosts a database 510 of resource enforcement policies 600 (FIG. 6) for one or more users. In accordance with an exemplary embodiment, the resource enforcement policy 600 can be for access and/or use of any resource within the enterprise in which the user has access via a mobile client 20a. For example, the resource enforcement policy 600 can apply to use and access to a multi-function printer (MFP) or image forming apparatus 30a, 30b. In accordance with an exemplary embodiment, the authentication server or SPS server 10b is configured to host a database 514 with the resource enforcement policy as set by the administrator and hosted on the directory server. For example, the database 514 can be hosted in the memory 220 of the authentication server or SPS server 10b.

In accordance with an exemplary embodiment, upon any changes in the resource enforcement policy 600 within the database 512 of the directory server 10c, in step 510, the new resource enforcement policy will automatically be synced with the database 514 in the user authentication server (or SPS server) 10b. In accordance with an exemplary embodiment, the syncing of the database 514 of the SPS server 514 with the database 512 of the directory server 10c can be based upon changes in the resource enforcement parameters (or resource enforcement policy) 600 within the database 512 of the directory server 10c, or can be synced based a pre-determined time period, for example, every 1 minute, every 5 minutes, every hour, every 12 hours, every 24 hours.

In accordance with an exemplary embodiment, when a user of a mobile client 20a, wishes to access resources within the enterprise 60 in step 520, the user of the mobile client 20a is authenticated with the authentication server (or SPS server) 10b in accordance with a single sign-on method or protocol as disclosed herein. In accordance with an exemplary embodiment, the user of the mobile client 20a is authenticated via the single sign-on method or protocol, for example, by biometrics or username and password. Upon authentication, the user and the mobile client 20a is given a user authentication certificate. In accordance with an exemplary embodiment, the certificate can be a public key certificate, for example, a public key issued in accordance with the X.509 standard.

The X.509 is a standard defining the format of public key certificates, which are used Internet protocols, including TLS/SSL, which is the basis for HTTPS. In action, X.509 can be used for secure protocol for browsing the web and offline applications, for example, electronic signatures. An X.509 certificate contains a public key and an identity (a hostname, or an organization, or an individual), and is either signed by a certificate authority or self-signed. When a certificate is signed by a trusted certificate authority, or validated by other means, someone holding that certificate can rely on the public key it contains to establish secure communications with another party, or validate documents digitally signed by the corresponding private key. X.509 also defines certificate revocation lists, which are a means to distribute information about certificates that have been deemed invalid by a signing authority, as well as a certification path algorithm, which allows certificates to be signed by intermediate certification authority (CA) certificates, which in turn, are signed by other certificates, eventually reaching a trust anchor. The structure of an X.509 version 3 (v3) digital certificate is as follows: Certificate, Version Number, Serial Number, Signature Algorithm ID, Issuer Name, Validity period (Not Before and Not After), Subject name, Subject Public Key Info (Public Key Algorithm and Subject Public Key), Issuer Unique Identifier (optional), Subject Unique Identifier (optional), and Extensions (optional).

In accordance with an exemplary embodiment, in step 530, the resource enforcement parameters 600 for the authenticated user can be pushed (i.e., initiated by the SPS server 10b to the MDM server 10a) in accordance with X.509 digital certification protocol. In accordance with an exemplary embodiment, for example, the administrator can configure the MDM server 10a in such a way that each of the resource enforcement policies are dynamically populated into the policies hosted on the MDM server 10a and thus, the MDM engine (i.e., CPU 210, memory 220, and programs 222) has direct access to the resource enforcement policies for each of the one or more users and mobile clients 20a directly. In accordance with an exemplary embodiment, in step 540, the MDM server 10a will have a certificate authority (CA) public key to verify the user's certification, or the with the multi-function printer (i.e., imaging forming apparatus or image forming device) 30a, 30b can use such a user certificate to enforce these resource constraints (for example, distributed MDM on each MFP or image forming apparatus 30a, 30b, or any other computing resource). In accordance with an exemplary embodiment, each multi-function printer (MFP) or image forming apparatus 30a, 30b can have a certificate authority (CA) public key to authenticate the user's certificate.

In accordance with an exemplary embodiment, the SPS server 10b and the MDM server 10a can be integrated in such a way that the authentication system (SPS server 10b) can push (i.e., create) the resource enforcement polices and corresponding user policies hosted on the MDM server 10a continuously (on-the-fly) as users are authenticated by the authentication system (SPS server 10b). In accordance with an exemplary embodiment, the resource enforcement policies hosted by the MDM server 10a can be removed from the MDM server 10a as users log out and/or upon a session of the user being terminated or ending. In accordance with an exemplary embodiment, the resource enforcement is always kept-alive based on the user state, such that the process is automatable.

FIG. 6 is a database of enforcement parameters 600 for a plurality of users in accordance with an exemplary embodiment. As shown in FIG. 6, for example, the directory server 10c can be configured to host one or more databased of users or user groups, for example, ID1, ID2, which have enterprise resource enforcement policies P1A, P1B, P2A, P3A, . . . , for example, for mobile printing from a mobile client 20a on a multi-function printer or image forming apparatus 30a, 30b. The enterprise resource enforcement policies can include, for example:

Max #(Cap) of mono Pages to print by user in a day, month, year

Max #(Cap) of color Pages to print by user in a day, month, year

In accordance with an exemplary embodiment, the resource enforcement parameters, P1A, P1B, P2A, P3A, . . . , can be associated with one or more print parameters, for example, the one or more print parameters being a number of pages to be printed for a given period of time and/or access to color printing. In accordance with an alternative embodiment, the resource enforcement parameter can be printer language commands or commands including settings related to: fonts, page format and spacing, number of print copies, tray selection and/or assignment, hard drive and/or memory, printing a single page of a document, the entire document, or a range of pages in the document, printing multiple copies of a document, printing the pages in a document in reverse order, printing multiple pages of a document on a single page of paper, landscape and portrait printing, printing on different page sizes, printing labels, duplex printing where both sides of a page are printed, and/or printing with watermarks, which can be controlled or monitored by an administrator. In addition, the resource enforcement parameters 600 can be related to the permission or limitations for accessing finishers (e.g., staple, folding, binding, die-stamping, embossing, laminating), or alternatively, for example, on location of mobile client 20a, or any other method of controlling or limiting a user to access of resources supported by the multi-function printer (MFP) or image forming apparatus 30a, 30b. In accordance with an exemplary embodiment, the resource enforcement parameter (or policy) P1A, P1B, P2A, P3A, . . . can be based on individual users, for example, ID1, ID2, . . . (FIG. 6), or each resource enforcement parameter (or policy) P1A, P1B, P2A, P3A, . . . , can be applied to groups, for example, executives, managers, administrative staff, etc.

In accordance with an exemplary embodiment, the resource enforcement parameters (or policies) 600 can be enforced by the MDM server 10a, or alternatively, the resource enforcement parameters (or policies 600) can be directly enforced by the multi-function printer or image forming apparatus 30a, 30b. For example, in accordance with an exemplary embodiment, the user authentication system (i.e., SPS server 10b) directly communicates with the multi-function printer (i.e., imaging forming apparatus or image forming device) 30a, 30b through the MDM server 10a, and the MDM server 10a can be configured to enforce the resource enforcement parameters 600, for example, by limiting number of sheets of print media that can be printed by a user.

In accordance with an exemplary embodiment, the enforcement of the resource enforcement parameters 600 is enforced by the multi-function printer (MFP) or image forming apparatus 30a, 30b, rather than enforcement through the MDM server 10a. For example, in accordance with an exemplary embodiment, the limiting of the number of sheets of print media that can be printed by the user is controlled or monitored by the multi-function printer (MFP) or image forming apparatus 30a, 30b upon receipt of the resource enforcement parameters 600 based on the certificate issued by the authentication server (SPS server 10b).

In accordance with an exemplary embodiment, the MDM server 10a forward the resource enforcement parameters 600 directly to each of the multi-function printers or imaging forming apparatuses 30a, 30b within the LAN (or enterprise) 60. In accordance with another exemplary embodiment, the user authentication system (i.e. SPS server 10b) can directly forward the resource enforcement parameters 600 to each of the multi-function printers or imaging forming apparatuses 30a, 30b rather than having the MDM server 10a forward the resource enforcement parameters 600 to each of the multi-function printers or imaging forming apparatuses 30a, 30b within the LAN (or enterprise) 60.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for resource enforcement on one or more multi-function printers from a mobile client, the method comprising:
hosting a database of resource enforcement parameters for one or more users on an authentication server, the database of resource enforcement parameters including a resource enforcement policy for each of the one or more users;
receiving authentication credentials from a user from the mobile client on the authentication server;
authenticating the user upon the receipt of authentication credentials from the mobile device; and
issuing a digital certificate for the user with resource enforcement parameters to the user from the database of resource enforcement parameters for the one or more users hosted on the authentication server, the digital certificate configured to control access of the user to resources hosted on the one or more multi-function printers in accordance with the resource enforcement policy for each of the one or more users.

2. The method according to claim 1, wherein the digital certificate is an X.509 certificate, and the method comprising:
attaching the resource enforcement parameters in an extension option of the X.509 certificate.

3. The method according to claim 1, comprising:
hosting a database of resource enforcement parameters for the one or more users on a directory server; and
synchronizing the database of resource enforcement parameters for the one or more users hosted on the authentication server with the database of resource enforcement parameters for the one or more users hosted on the authentication server.

4. The method according to claim 3, wherein the synchronization of the database of resource enforcement parameters for the one or more users hosted on the authentication server with the database of resource enforcement parameters for the one or more users hosted on the directory server comprises:
changing a resource enforcement parameter for the user in the database of resource enforcement parameters for the one or more users hosted on the directory server; and
immediately synchronizing the database of resource enforcement parameters for the one or more users hosted on the authentication server with the database of resource enforcement parameters for the one or more users hosted on the directory server.

5. The method according to claim 3, wherein the synchronization of the database of resource enforcement parameters for the one or more users hosted on the authentication server with the database of resource enforcement parameters for the one or more users hosted on the directory server comprises:
periodically synchronizing the database of resource enforcement parameters for the one or more users hosted on the authentication server with the database of resource enforcement parameters for the one or more users hosted on the directory server.

6. The method according to claim 1, further comprising:
managing the mobile client of the user with a mobile device management server; and
sending the resource enforcement parameters for the user from the database of resource enforcement parameters for one or more users hosted on the authentication server to the mobile device management server for enforcement of the resource enforcement parameters.

7. The method according to claim 6, comprising:
sending a print job from the mobile device to a multi-function printer of the one or more multi-function printers; and
enforcing the resource enforcement parameters in the digital certificate with the mobile device management server.

8. The method according to claim 6, comprising:
sending a print job from the mobile device to a multi-function printer of the one or more multi-function printers;
enforcing the resource enforcement parameters in the digital certificate on the multi-function printer, and wherein the multi-function printer is configured to enforce the resource enforcement parameters rather than the mobile device management server.

9. The method according to claim 1, further comprising:
authenticating the user on the mobile device via a single sign-on (SSO) method.

10. The method according to claim 1, wherein the resource enforcement parameters pertain to one or more print parameters, the one or more print parameters being a number of pages to be printed for a given period of time and/or access to color printing.

11. A non-transitory computer readable medium storing computer readable program code executed by a processor for a method for resource enforcement on one or more multi-function printers from a mobile client, the method comprising:
hosting a database of resource enforcement parameters for one or more users on an authentication server, the database of resource enforcement parameters including a resource enforcement policy for each of the one or more users;
receiving authentication credentials from a user from the mobile client on the authentication server;
authenticating the user upon the receipt of authentication credentials from the mobile device; and
issuing a X.509 digital certificate for the user with resource enforcement parameters in an extension option of the X.509 certificate to the user from the database of resource enforcement parameters for the one or more users hosted on the authentication server, the X.509 digital certificate configured to control access of the user to resources hosted on the one or more multi-function printers in accordance with the resource enforcement policy for each of the one or more users.

12. The non-transitory computer readable medium according to claim 11, comprising:
hosting a database of resource enforcement parameters for the one or more users on a directory server; and
synchronizing the database of resource enforcement parameters for the one or more users hosted on the authentication server with the database of resource enforcement parameters for the one or more users hosted on the authentication server.

13. The non-transitory computer readable medium according to claim 12, wherein the synchronization of the database of resource enforcement parameters for the one or more users hosted on the authentication server with the database of resource enforcement parameters for the one or more users hosted on the directory server comprises:
changing a resource enforcement parameter for the user in the database of resource enforcement parameters for the one or more users in the directory server; and
immediately synchronizing the database of resource enforcement parameters for the one or more users hosted on the authentication server with the database of resource enforcement parameters for the one or more users hosted on the directory server.

14. The non-transitory computer readable medium according to claim 12, wherein the synchronization of the database of resource enforcement parameters for the one or more users hosted on the authentication server with the database of resource enforcement parameters for the one or more users hosted on the directory server comprises:
periodically synchronizing the database of resource enforcement parameters for the one or more users hosted on the authentication server with the database of resource enforcement parameters for the one or more users hosted on the directory server.

15. The non-transitory computer readable medium according to claim 11, further comprising:
managing the mobile client of the user with a mobile device management server;
sending the resource enforcement parameters for the user from the database of resource enforcement parameters for one or more users hosted on the authentication server to the mobile device management server for enforcement of the resource enforcement parameters;
sending a print job from the mobile device to a multi-function printer of the one or more multi-function printers; and
enforcing the resource enforcement parameters in the digital certificate with the mobile device management server.

16. The non-transitory computer readable medium according to claim 11, further comprising:
authenticating the user on the mobile device via a single sign-on (SSO) method.

17. A system for resource enforcement on one or more multi-function printers from a mobile client, the system comprising:
an authentication server configured to:
host a database of resource enforcement parameters for one or more users, the database of resource enforcement parameters including a resource enforcement policy for each of the one or more users;
receive authentication credentials from a user from the mobile client;
authenticate the user upon the receipt of authentication credentials from the mobile device; and
issue a X.509 digital certificate for the user with resource enforcement parameters in an extension option of the X.509 certificate to the user from the database of resource enforcement parameters for the one or more users on the authentication server, the X.509 digital certificate configured to control access of the user to resources hosted on the one or more multi-function printers in accordance with the resource enforcement policy for each of the one or more users.

18. The system according to claim 17, further comprising:
a directory server configured to:
host a database of resource enforcement parameters for the one or more users; and
synchronize the database of resource enforcement parameters for the one or more users hosted on the authentication server with the database of resource enforcement parameters for the one or more users hosted on the authentication server upon a change of a resource enforcement parameter for the user in the database of resource enforcement parameters for the one or more users hosted in the directory server, or periodically synchronizing the database of resource enforcement parameters for the one or more users hosted on the authentication server with the database of resource enforcement parameters for the one or more users hosted on the directory server.

19. The system according to claim 17, further comprising:
a mobile device management server configured to:
managing the mobile client of the user; and
receive the resource enforcement parameters for the user from the database of resource enforcement parameters for one or more users hosted on the authentication server for enforcement of the resource enforcement parameters.

20. The system according to claim 19, wherein the mobile client is configured to send a print job from the mobile device to a multi-function printer of the one or more multi-function printers; and
the mobile device management server is configured to:
enforce the resource enforcement parameters in the digital certificate.
